(19) United States
(12) Patent Application Publication
(10) Pub. No.: US 2008/0169167 A1
(43) Pub. Date: Jul. 17, 2008

(54) PULLING TYPE DRIVE SHAFT-FITTING JIG ASSEMBLY

(75) Inventor: Gwuiseon LEE, Gyeonggi-do, (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Seoul (KR)

(21) Appl. No.: 11/877,232

(22) Filed: Oct. 23, 2007

(30) Foreign Application Priority Data
Jan. 11, 2007 (KR) 10-2007-0003310
Jun. 29, 2007 (KR) 10-2007-0065047

(51) Int. Cl. F16D 13/68

(52) U.S. Cl. 192/115

(57) ABSTRACT

According to the present invention, a drive shaft DS is fitted into an axle hub AH with the drive shaft DS and a jig assembly arranged on an axis. Accordingly, a separate working place is not required because the fitting is performed in an assembly line where the components of a vehicle are assembled. Further, because the drive shaft DS is axially pulled, damage to peripheral parts of the axle hub AH, such as a constant velocity joint, is prevented. In addition, it is possible to set axial load of the drive shaft DS using a load cell, so that it can be applied to axial load between about 700 kgf and 1600 kgf.

### CROSS-REFERENCE TO RELATED APPLICATIONS

The present application is based on, and claims priority from, Korean Application Serial Number 10-2007-0003310 and 10-2007-0065047, filed on Jan. 11, 2007 and Jun. 29, 2007, the disclosure of which is hereby incorporated by reference herein in its entirety.

### FIELD OF THE INVENTION

The present invention relates to a pulling type drive shaft-fitting jig assembly, particularly a pulling type drive shaft-fitting jig assembly that fits a drive shaft into an axle hub while axially pulling the drive shaft.

### BACKGROUND OF THE INVENTION

In general, driving torque that is generated by an engine and is converted by a transmission is transmitted to driving wheels through a driven reduction gear and a differential.

Connected to the driving wheels to transmit the driving torque, the drive shaft is fitted in axle hubs of the driving wheels to transmit the driving force from the driven reduction gear and to withstand the load.

The driving shaft should be strongly fitted in the axle hub; therefore, it is generally assembled by specific fitting equipment. In detail, with the axle hub lying on the frame of the jig assembly, the end of the drive shaft is vertically positioned to the hub, a connection hole of the axle hub, and then the end of the drive shaft is pressed by high pressure to fit into the hub.

However, because the equipment for forcible fitting require devices that locate the axle hub, and support and press down the drive shaft, generally a large work place and at least three operators are needed for assembly and supply of components with high equipment cost.

Further, since the end of the drive shaft is fitted into the axle hub that is in place by high pressure in the equipment, the constant velocity joint of the axle hub may be damaged, or if severed, broken in fitting the drive shaft. Accordingly, it is difficult to maintain the quality.

Further, because the vertically pressed position of the drive shaft should be accurately aligned with the axle hub in fitting, compatibility between the axle hub and peripheral components, such as the constant velocity joint, is bad in fitting the drive shaft, and if the assembly compatibility is severe, cost for changing the design and improving the quality is increased.

### SUMMARY OF THE INVENTION

Embodiments of the present invention provides a pulling type drive shaft-fitting jig assembly in which a drive shaft located on the axis of an axle hub is horizontally pulled in the axial direction of the axle hub when the drive shaft is fitted into the hub, a connection hole of the axle hub. Therefore, the peripheral components of the axle hub are not damaged by the fitted drive shaft nor decreased in quality.

Further, according to embodiments of the invention, a jig assembly that fits the drive shaft into the axle hub while pulling the end horizontally in the axial direction of the axle hub is used. Accordingly, it is possible to fit the drive shaft in the axle hub without specific equipment for supporting and pressing the drive shaft, maintaining the position of the axle hub. Therefore, it is possible to manufacture the entire equipment for the jig assembly in a small size and save manufacturing and managing cost.

Further, according to embodiments of the invention, with the axle hub, drive shaft, and jig arranged horizontally on an axis, the drive shaft is strongly pulled by a jig assembly disposed at the opposite side to the axle hub using hydraulic or pneumatic pressure. Therefore, operations for supporting and fixing the axle hub and drive shaft are almost not needed and only one operator is sufficient for the fitting.

Further, according to embodiments of the invention, fitting of the drive shaft in the axle hub is achieved by a small jig assembly using hydraulic or pneumatic pressure. Accordingly, the fitting can be made in an assembly line of the axle hub and the drive shaft, not a specific work place. Therefore, it is possible to prevent inefficiency due to preparation and maintenance of a specific work place.

Further, according to embodiments of the invention, with the axle hub, drive shaft, and jig arranged horizontally on an axis, when the drive shaft is strongly pulled by hydraulic or pneumatic pressure, it is possible to set the magnitude of the axial pulling load and check changes in the axial pulling force. Therefore, more accurate work is possible.

Further, according to embodiments of the invention, the jig assembly is applicable to various structures by variously modifying the axial pulling structure of the drive shaft that is forcibly fitted into the axle hub by a jig assembly.

A pulling type drive shaft-fitting jig assembly includes a driving means generating power. A shaft pulling maintainer is disposed between a reciprocating shaft of the driving means and a drive shaft forcibly fitted into an axle hub such that the axis of the driving means is arranged in the axis direction of the drive shaft in order to pull the drive shaft using axial load from the driving means. The jig assembly is controlled by the driving means and a controller of a control circuit.

The driving means generates axial pulling force using hydraulic pressure supplied from a power source through a pipe connecting the power source and driving means and has an operation switch transmitting operational signals to the controller for generating axial pulling force. The shaft pulling maintainer has a supporting member that supports the sides of the axle hub to restrict axial movement of the axle hub, when the drive shaft is axially pulled. A shaft-pulling member that axially pulls the drive shaft using the axial pulling force transmitted from the driving means is disposed at the inside from the supporting member.

The supporting member includes long shaft-shaped bars to maintain a predetermined interval between the axle hub and the driver of the driving means. One end of the supporting bar is connected to a supporting case with a through hole in front of the driver in order not to interrupt movement of the shaft of the driver. The other end of the supporting bar is connected with a positioner that is in close contact with the surface of the axle hub and restricts the axle hub when the drive shaft is axially moved.

The shaft pulling member includes a connecting end that is connected to the shaft of the driver and transmits the axial pulling force and a pulling socket which is connected to connecting end on the same axis as the connecting end and of which the other end is connected to the drive shaft. The shaft-pulling member operates in a direct type such that the connecting end connected with the pulling socket without a gap.

Therefore, the direct shaft-puling member has an insert end the pulling socket. The insert end is formed at the opposite side to a connection shaft that is connected to the actuating rod of the driver, with a step between the insert end and the connection shaft. The pulling socket has a connection groove to fit the insert end, opposite to a hollow extending connection shaft connected to the drive shaft.

The connection groove of the pulling socket has an open slot that is open to a side to easily fit the insert end of the connecting end and an insertion that is in close contact with the sides to axially restrict the fitted insert end.

Further, the shaft pulling maintainer has the load setter to check axial load exerted in the drive shaft DS pulled by the power from the driving means. The intermediate connecting members maintaining a predetermined interval of the front and rear of the load setter is provided on the axis of the driving means around the load setter. The controller that inputs/outputs control signals generates control signals to operate the driving means and is controlled with the load setter in feed-back type.

The load setter is disposed between the connecting end and the shaft of the driver. The connecting end is disposed at the inside from the supporting member supporting the sides of the axle hub when the drive shaft is forcibly fitted, and fitted in the pulling socket threaded-fastened to axially pull the drive shaft. The shaft of the driver is connected to apply axial pulling force from the hydraulic driver of the driving means to the connecting end such that the shaft of the driver passes through. Further, the shaft of the driver is connected through the controller and a junction box.

The load setter has a signal connection end and a load sensor. The signal connection end is connected to the controller to transmit axial load signals or input control signals. The load sensor has the signal connection end at one side that is disposed around the actuating rod of the driver such that the actuating rod passes through.

The intermediate connecting member is connected to the driver through a supporting bracket. An interval from the load setter is defined by connecting rods of which one ends are connected to the supporting bracket and the other ends are connected to the supporting case that is in close contact with the load setter opposite to the supporting bracket.

Further, the intermediate connecting member is disposed between the driver of the driving means 1 and the supporting member. The supporting member has the positioner that is in close contact with the surface of the axle hub and the supporting bars that connect the positioner with the supporting case. The connecting rods of the intermediate connecting member are integrally formed with the supporting bars.

### BRIEF DESCRIPTION OF THE DRAWINGS

For better understanding of the nature and objects of the present invention, reference should be made to the following detailed description with the accompanying drawings, in which:

FIG. 1 is an exploded view showing components of a pulling type drive shaft-fitting jig assembly according to an embodiment of the invention;

FIGS. 2A and 2B are views illustrating an indirect shaft-pulling member composed of a connecting link and a pulling socket and relationship between the indirect shaft-pulling member, an axle hub, and a drive shaft in the jig according to an embodiment of the invention;

FIG. 3 is a view showing a modification for the indirect shaft-pulling member according to an embodiment of the invention;

FIG. 4 is a view showing a modification for the indirect shaft-pulling member according to an embodiment of the invention;

FIG. 5 is a view showing an assembled pulling type drive shaft-fitting jig assembly according to an embodiment of the invention;

FIGS. 6A and 6B are views illustrating work flow using a pulling type drive shaft-fitting jig assembly according to an embodiment of the invention;

FIGS. 7A and 7B are views illustrating a drive shaft fitted in an axle hub by a pulling type drive shaft-fitting jig assembly according to an embodiment of the invention;

FIG. 8 is a view illustrating the operation forcibly fitting a drive shaft into a hub while pulling the drive shaft using an indirect shaft-pulling member of a pulling type drive shaft-fitting jig assembly according to an embodiment of the invention;

FIG. 9 is a view illustrating a drive shaft forcibly fitted in an axle hub by a pulling type drive shaft-fitting jig assembly according to an embodiment of the invention;

FIGS. 10A and 10B are views showing modifications for nuts that are screwed onto a threaded portion of a drive shaft fitted in an axle hub according to an embodiment of the invention;

FIG. 11 is a view illustrating a pulling type drive shaft-fitting jig assembly with a load sensor for setting load according to an embodiment of the invention;

FIG. 12 is a view showing a modification of a pulling type drive shaft-fitting jig assembly of FIG. 11 for an assembly line; and

FIG. 13 is a view showing the pulling type drive shaft-fitting jig assembly with a load sensor for setting load of FIG. 12 installed in an assembly line.

### DETAILED DESCRIPTION OF THE PREFERRED EMBODIMENTS

Hereinafter, preferred embodiments of the invention are described with reference to accompanying drawings.

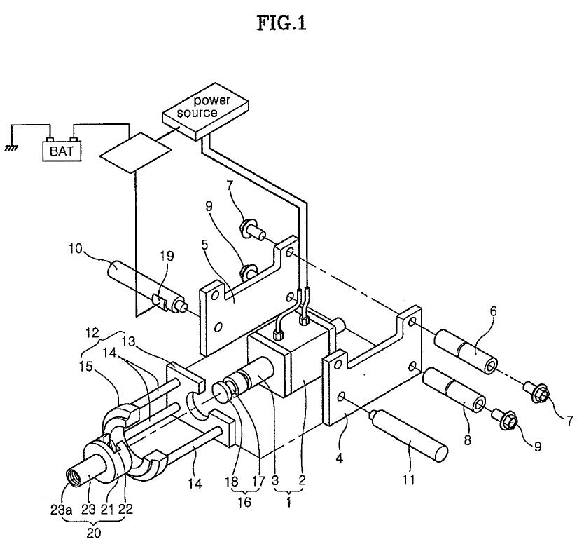

FIG. 1 is an exploded view showing components of a pulling type drive shaft-fitting jig assembly according to an embodiment of the invention. A pulling type drive shaft-fitting jig assembly according to an embodiment of the invention includes a driving means 1 that is controlled through hydraulic or pneumatic control by a controller to generate power. A shaft pulling maintainer is installed on the axis of driving means 1 to forcibly fit a drive shaft DS into an axle hub AH by applying axial pulling force in the axial direction of drive shaft DS. A controller composing a control circuit is provided to control driving means 1.

In the components of the fitting jig assembly having a variety of structures according to an embodiment of the invention, driving means 1, for example, includes a driver 2 connected to the power source that is controlled by the controller through a pipe (e.g. hose) and generating axial power and an actuating rod 3 axially reciprocating by an operating means that reciprocates in driver 2.

The power is hydraulic or pneumatic pressure and driver that is actuated by the power has a hydraulic or pneumatic cylinder. The axial pulling force of driver 2 ranges between 700 kgf to 1600 kgf for fitting drive shaft DS into axle hub AH.

Driving means 1 is received in a predetermined-shape housing, which generally has housing cases 4, 5 covering the sides of driver 2.

For example, the housing has a pair of housing cases 4, 5 that are located at both sides of driver 2 to receive and fix it with the upside opened, guide bars that are disposed inside housing cases 4, 5 and fix them, adjusting the interval, and fastening bolts that are screwed through housing cases 4, 5 to fix the guide bars.

The guide bar is composed of upper/lower guide bars 6, 8 that are arranged above and below at a distance at an end of and between housing cases 4, 5 and fastening bolts 7, 9 that are screwed in upper/lower guide bars 6, 8 through housing cases 4, 5 to fasten guide bars 6, 8 to housing cases 4, 5.

Provided to driving means 1 to allow an operator to easily move it, a handle is composed of left/right bars 10, 11 having a sufficient length to allow easy hold at the sides of housing cases 4, 5 of the housing. Left/right bars 10, 11 allow an operator to move driving means 1 by hand.

Left/right bars 10, 11 may be fitted in holes formed through housing cases 4, 5 or fastened by forming a thread on them.

An operation switch 19 for driving means 1 that transmits operational signals by an operator to the controller may be disposed at several positions, but is disposed at one of left/right bars 10, 11 (left bar 10 in this embodiment) and composes a power circuit with the controller.

Operation switch 19 generally turns on/off driver 2 by shifting.

The shaft pulling maintainer has a supporting member 12 that supports the side of axle hub AH to restrict axial movement of axle hub AH, when drive shaft DS is axially pulled and a shaft-pulling member that axially pulls drive shaft using axial pulling force transmitted from driving means 1.

The shaft-pulling member is located at the inside from supporting member 12.

Supporting means 12 includes long axial supporting bars 14 to maintain a predetermined interval between driver 2 of driving means 1 and axle hub AH. The driver-sided ends of supporting bars 14 are fixed to a supporting case 13 that blocks the front of driver 2 and the axle hub-sided ends of supporting bars 14 are fixed to a positioner 15 that is in close contact with the surface of axle hub AH.

A plurality of supporting bars 14 is provided to keep the support against axle hub AH uniform, but it is preferable for supporting bars 14 to be composed of four supporting bars in total, a pair of upper and lower bars at both sides of supporting case 13.

Supporting case 13 is combined with housing cases 4, 5 at both sides of driver 2 and has a through hole at the center in order not to interrupt the reciprocation of actuating rod 3 of driver 2.

Positioner 15 may have a variety of structures with a through hole at the center to allow the shaft-pulling member to axially move, but has a ring shape for uniform contact force to axle hub AH in this embodiment.

Since supporting member 12 restricts axle hub AH in axial pulling by close contact to axle hub AH, an interval should be maintained for close contact to axle hub AH. Therefore, the interval is determined in design of the jig assembly according to the length of supporting bars 14 of supporting member 12 or supporting bars 14 are threaded-fastened to supporting case 13 such that the length of supporting bars is variable.

The shaft-pulling member includes a connecting end 16 that exerts pulling force by pulling of driver 2 in operation is connected to actuating rod 3 of driver 2 and a pulling socket 20 that is connected to the end of drive shaft and to connecting end 16 to forcibly fitting drive shaft DS into a hub h, a connection hole of axle hub AH by pulling with connecting end 16 axially pulled by driver 2.

The shaft-pulling member may be configured in an indirect type or a direct type according to the way of transmitting axial pulling force, which improves applicability for the interval between driver 2 generating power and axle hub AH and transmission efficiency of axial pulling force for drive shaft DS as well.

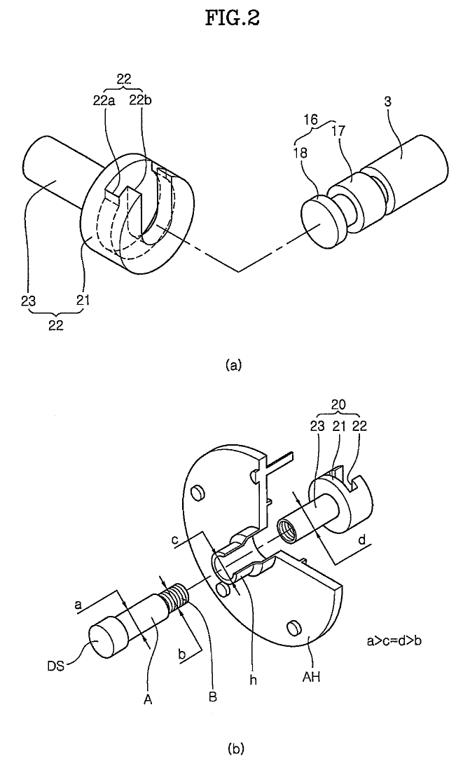

According to a direct-typed shaft-pulling member, as shown in FIG. 2A, the connecting end 16 connected to actuating rod 3 of driver 2 is threaded-fastened to the hole of actuating rod 3 through a connection shaft 17 and an insert end 18 is formed at the end of the connection shaft 17 with a step between insert end 18 and connection shaft 17.

Connecting end 16 may be integrally formed with actuating rod 3 of driver 2, for example, in which connection shaft 17 having a smaller diameter than actuating rod 3 is formed at the end of actuating rod 3 and end connecting portion 18 having a large diameter than connection shaft 17 is formed coaxially at the end of connection shaft 17.

Pulling socket 20 has a socket end 21 that is connected to connecting end 16 connected to actuating rod 3 to receive the pulling force from driver 2 and a hollow extending connection shaft 23 that is coaxially formed with a smaller diameter than socket end 21 and connected to drive shaft DS at the opposite side to socket end 21.

Socket end 21 has a connection groove 22 where insert end 18 of connecting end 16 is inserted. For example, connection groove 22 is open at a side to easy connection to and disconnection from connecting end 16 and has an insertion 22a through which connecting end 16 is inserted and an open slot 22b that is open to a side and communicated with insertion 22a.

Socket end 21 is formed to have a diameter such that it can pass through the hole formed through positioner 15 of supporting member 12.

Connection groove 22 of socket end 21 is formed such that when actuating rod 3 is pulled, the pulling force is exerted in the entire pulling socket 20, because a large portion of insert end 18 of connecting end 16 is in contact with the inside of socket end 21 with insertion 22a of connection groove 22, so that the axial pulling force applied by driver 2 is exerted throughout the entire pulling socket 20.

Extending connection shaft 23 is changed in shape according to the shape of the end of drive shaft DS and has an inside-threaded end 23a, corresponding to a threaded shaft B at the end of drive shaft for threaded-fastening.

The threaded-fastening of the components of the shaft-pulling member of direct type is designed such that the threaded-fastened portions are not deformed or broken even though pulling force of 700 kgf to 1600 kgf is applied that is generated when drive shaft DS is inserted into axle hub AH with the jig assembly in operation. Accordingly, the threaded-fastened portions are formed of a material that has undergone heat treatment or has sufficient rigidity.

Since drive shaft DS provisionally assembled with axle hub AH is fitted by axle pulling force with the end, which protrudes through axle hub AH, being in threaded-fastening, the diameters of connecting portions have appropriate differences.

Referring to FIG. 2B showing an example of the above-mentioned configuration, the diameter d of extending connection shaft 23 of pulling socket 20 is the same as or slightly smaller than the diameter c of the hub h of axle hub AH, the diameter b of threaded shaft B of drive shaft DS is smaller than diameter c of hub h of axle hub and the same as the inner diameter of inside-threaded end 23a of extending connection shaft 23.

A fitted-shaft A of drive shaft that is forcibly fitted in hub h of axle hub AH is larger than diameter c of hub h of axle hub AH and the diameter difference is set such that fitted-shaft A of drive shaft DS is firmly fixed in hub h of axle hub AH, which is generally applied for fitting-connection of drive shaft DS and axle hub AH.

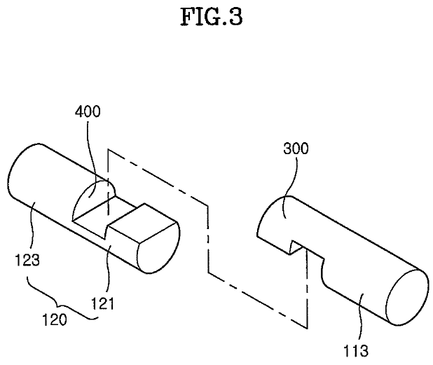

The direct-typed shaft-pulling member that is threaded-fastened may be connected in other ways, not threaded fastening. For example, according to a configuration of a shaft-pulling member shown in FIG. 3, a driving connection step 300 is directly formed on actuating rod 113 of driver 2 and a driven connection step 400 is formed on a driven body 121 opposite to a hollow threaded shaft 123 that is threaded-fastened with the end of drive shaft DS. Accordingly, a shaft-pulling member 120 is formed by connecting driving connection step 300 with driven connection end 400.

Driving connection step 300 and driven connection end 400 may be formed in a variety of structures, and for example, a protrusion and recession may be formed for locking of driving connection step 300 and driven connection step 400 that are overlapped. Alternatively, driving step 300 and driven step 400 may be locked by a hook and axially pulled.

Hollow threaded shaft 123 of pulling member 120 with driven connection step 400 is formed of a material that has undergone heat treatment or has sufficient rigidity against axial load of 700 kgf to 1600 kgf that is applied in fitting drive shaft DS.

An indirect-typed shaft-pulling member, a modification for the above shaft-pulling member, provides convenience that fitting of drive shaft DS into axle hub AH is possible even with large distance between driver 2 and drive shaft DS.

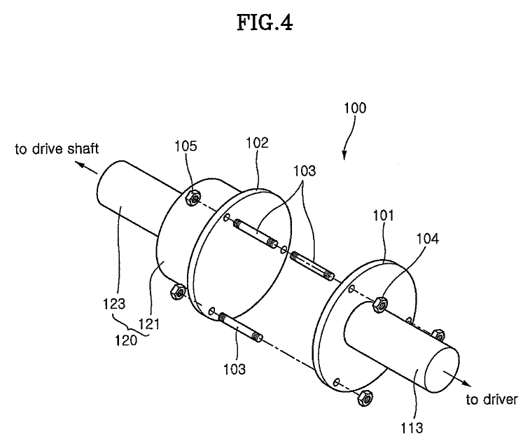

According to an indirect-typed shaft-pulling member 100, as shown in FIG. 4, a driving connection end 101 is formed in a larger diameter than actuating rod 113 at the end of actuating rod 113 of driver 2 and a driven connection end 102 is formed in a larger diameter than a driven body 121 of pulling member 120 at the opposite side to hollow threaded shaft 123, and indirect connecting members 103 that connect driving connection end 101 and driven connection end 102 through holes formed in them to transmit the axial pulling force applied from driving connection end 101.

Indirect connecting member 103 may be formed in a variety of structures, but is a long shaft-shaped bar with threads on both ends in this embodiment. Indirect connecting member 103 is inserted in the hole of driving connection end 101 and driven connection end 102 and then nuts 104, 105, fixing members, are threaded-fastened to both ends for fixing.

Indirect connecting member 103 may be formed of a simple steel wire, not the long shaft-shaped bar.

Further, a plurality of indirect connecting members 103 are provided for uniform support against axle hub AH and it is preferable to arrange three at 120° intervals in total.

Hollow threaded shaft 123 of pulling member 120 with driven connection end 102 is made of a material that has undergone heat treatment of sufficient rigidity against axial load of 700 kgf to 1600 kgf that is applied in fitting drive shaft DS.

The pulling type drive shaft-fitting jig assembly may be modified into more convenient types, and for example, may be configured such that it can set and monitor the axial load from driver 2.

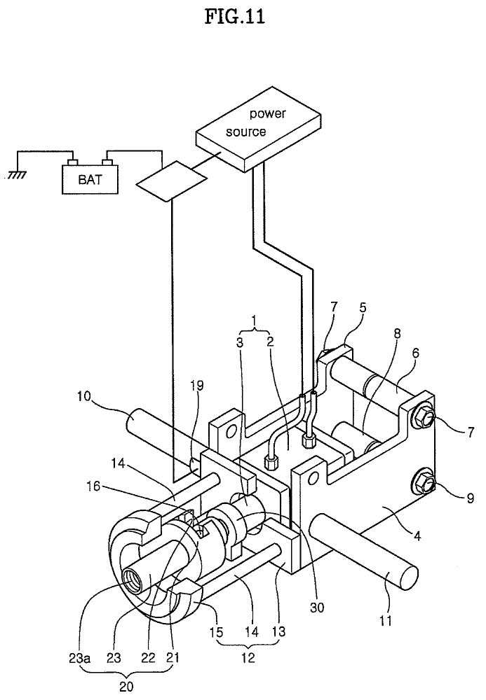

A pulling type drive shaft-fitting jig assembly having the above-mentioned configuration, as shown in FIG. 11 by way of example, includes driving member 1 that is controlled by a controller to generate power using hydraulic or pneumatic pressure, a load-setting means that is installed on the axis of driving means to know the axial load applied, and a shaft pulling maintainer having a shaft-pulling member that is connected to supporting member 12 supporting the sides of axle hub AH and axially pulled in order to apply axial pulling force of driving means 1 to drive shaft DS in the axial direction of drive shaft DS.

The jig assembly shown in FIG. 11 has the same configuration as the jig assembly shown in FIG. 1, except for the load-setting means on the axis of driving means 1, the load-setting means is generally a load cell, a load setter 30.

The load cell generates signals corresponding to the magnitude of the load in response to the load axially applied or allows an operator to recognize the magnitude of the axial load applied in fitting drive shaft DS into axle hub AH.

The pulling type drive shaft-fitting jig assembly that can set and monitor axial load from driver 2 particularly allows requirements for the vehicle assembly line to be more positively reflected.

For example, for an assembly line for various vehicles, the function of driver 2 setting and monitoring axial load applied to drive shaft DS can rapidly cope with difference in fitting force required between drive shaft DS and axle hub AH of the types of vehicle.

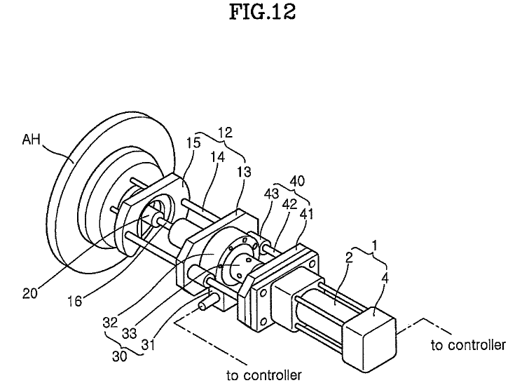

The pulling type drive shaft-fitting jig assembly equipped with the load sensor deforms to automatically operate in the vehicle assembly line, that is, as shown in FIG. 12, the power generator includes driving means 1 that is controlled by a controller to generate power through hydraulic or pneumatic control.

Further, a load-setting means is installed on the axis of driving means 1 to set or measure the axial load from driving means 1 with a controller 60 and a shaft pulling maintainer that transmits axial pulling force from driving means 1 to drive shaft DS in the axial direction of drive shaft DS is installed.

In addition, since the pulling type drive shaft-fitting jig assembly equipped with the load sensor is applied to a vehicle assembly line, the jig assembly is mounted by the equipment in the assembly line such that it can move to drive shaft DS and axle hub AH moving to the assembly line.

This mounting structure is configured generally by a variety of ways applied to the assembly line, for example, a rack-and-pinion for up/down and front/back movement or combination of rails.

The jig assembly also has the same configuration as the jig assembly shown in FIG. 1, except for some of the components, but the shape of each component is changed according to characteristics of the vehicle assembly lines.

For example, driving means 1 that generates axial pulling force in operation includes driver 2 with an actuating rod that moves in/out to generate axial power in operation and housing case 4 that supports driver 2 around it.

Driver 2, as in FIG. 1, is connected to the power source that is controlled by the controller through a pipe (e.g. hose) to generate axial power, may include a hydraulic or pneumatic cylinder according to the types of the power source, and generates axial pulling force between 700 kgf to 1600 kgf.

However, housing case 4 surrounding driver 2 surrounds the front and rear ends of driver 2 to support it, depending on characteristics of the assembly line that should allow free movement of the entire jig assembly to move to axle hub AH and drive shaft DS.

Further, the shaft pulling maintainer, as in FIG. 1, has supporting means 12 that supports the sides of axle hub AH to restrict axial movement of axle hub AH, when drive shaft DS is axially pulled, is composed of a shaft-pulling member that axially pulls drive shaft using the axial pulling force transmitted from driver 2, and the shaft-pulling member is located at the inside from supporting member 12.

However, in supporting member 12, a supporting bar 14 of which one end is connected to both sides of positioner 15 that closely contacts with the surface of axle hub AH, supporting case 13 with supporting bars 14 connected at the opposite side to positioner 15 closely contacts with the load-setting means. Accordingly, a gap of the length of supporting bar 14 is defined between positioner 15 and supporting case 13.

Positioner 15 is open at the bottom to easily dispose the jig assembly to the axle hub AH that is located under.

The shaft-pulling member also includes connecting end 16 connected to the end of the actuating rod that axially moves by the operation of driver 2 and pulling socket 20 that is connected to connecting end 16 and axially pulls drive shaft DS to be inserted into axle hub AH. Connecting end 16 is located in front of the load-setting means through which the actuating rod axially moves when driver 2 is in operation.

The shaft-pulling member may be configured in an indirect type or a direct type according to the way of transmitting axial pulling force. The modifications as the indirect shaft-pulling member of FIG. 3 and the direct shaft-pulling member of FIG. 4 are equally applied to the above shaft-puling member.

However, the jig assembly shown in FIG. 12 is not provided with an operation switch for driving driver 2, unlike to the jig assembly shown in FIGS. 1 and 11, because it is installed in a vehicle assembly line in which driver 2 is controlled by a controller 60 that is separately installed from driver 2.

The load-setting means that sets and monitors the axial load from driver 2 is load setter 30 connected with controller 60 and load setter 30, as shown in FIG. 12, has a signal connection end 31 connected to controller 60 to transmit axial load signals or input control signals and a load sensor 32 through which the actuating rod is disposed and of which a side is connected with signal connection end 31.

Further, a hollow shaft connection end 33 that axially extends, surrounding the shaft passing through load sensor 32, is formed.

Load sensor 32 generates measured signal values for the magnitude of axial load in a variety of ways, preferably in a load cell type.

Further, load setter 30 is more safely protected on the axis, for which an intermediate connecting member 40 that maintains a predetermined interval at the front and rear of load setter 30 is used.

Intermediate connecting member 40, as shown in FIG. 12, includes a supporting bracket 41 that is connected to driver 2 and connecting rods 42 that are connected with supporting bracket 41 at an end and to supporting case 13 that is in close contact to load setter 30 at the opposite end. Connecting rods 42 maintains a predetermined interval from load setter 30.

Connecting rod 42 is integrally formed with supporting bar 14 of supporting member 12. Connecting rods 42 passing through supporting case 13 are supported by hollow supporting end 43 protruding at both sides of supporting case 13.

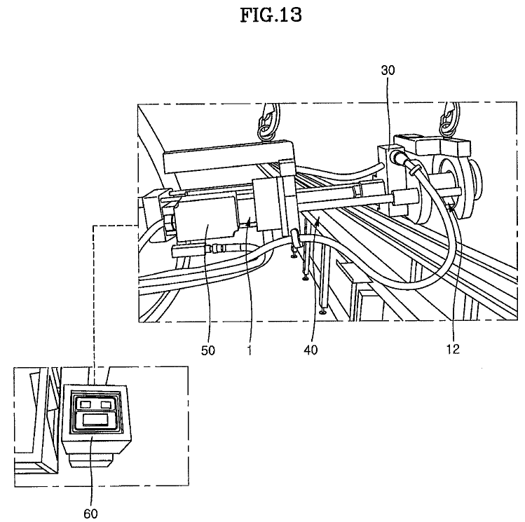

Further, a jig assembly equipped with a load-measuring unit, such as a load cell, which is applied to a vehicle assembly line, as shown in FIG. 13, includes load setter 30, driver 2, and a junction box 50 gathering signal lines for all of the components that receive signals relating to control. Junction box 50 is generally located to driving means 1 having driver 2.

Controller 60 controlling all of the components as well as load setter 30 and driver 2 transmits control values required for an operator and includes an input unit and a monitor that determines measured values in real time. Further, controller 60 is located such that it can improve convenience for an operator in the assembly line.

The operation of the invention is now described with reference to the accompanying drawings.

According to an embodiment of the invention, when drive shaft DS is fitted into hub h, a hole of axle hub AH, as drive shaft horizontally disposed in the axial direction of axle hub AH is axially pulled by a jig assembly, drive shaft DS is axially moved. Therefore, it is possible to prevent damage to peripheral parts (e.g. constant velocity joint) of axle hub AH, due to drive shaft forcibly fitted.

As described above, according to an embodiment of the invention, since fitting is possible by axial pulling between axle hub AH and drive shaft DS, direct fitting is performed in an assembly line for assembling components of a vehicle; therefore, it is possible to effectively use the space because a separate work space for fitting is not needed. Further, since drive shaft DS is fitted in axle hub AH using the axial pulling way of the jig assembly, it is possible to reduce the size of the jig assembly and considerably save manufacturing cost as well.

In other words, since the entire drive shaft DS is not pressed against axle hub AH, whereas drive shaft DS is axially pulled as much as the width of axle hub AH for fitting with the end fastened; the jig assembly can be manufactured in the independent total size from the total length of drive shaft DS. Accordingly, it is possible to reduce the entire size with the work space occupied by the jig assembly.

Further, according to an embodiment of the invention, when drive shaft DS is fitted into axle hub AH by the jig assembly, it is possible to set the axial load for fitting drive shaft DS into axle hub AH. Accordingly, the invention is applicable to various specifications requiring axial load between about 700 kgf to 1600 kgf.

The above advantages can be achieved, because the jig assembly is configured such that it is disposed in the axial direction of drive shaft DS at the front and rear of axle hub AH and axially pulling drive shaft DS.

Further, the pulling type drive shaft-fitting jig assembly is used in vehicle assembly lines or may be moved, if needed.

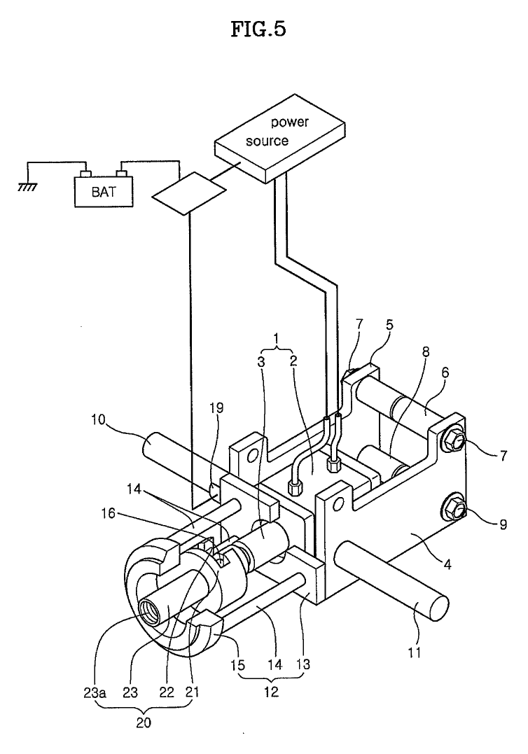

Describing the operation of the pulling type drive shaft-fitting jig assembly with reference to FIG. 5 by way of example, the jig assembly includes driver 2 for generating power that is mounted inside, with upper/lower guide bars 6, 8 and housing cases 4, 5 fastened by bolts.

Connecting end 16, the direct shaft-pulling member and pulling socket 20 are disposed in front of driver 2. In detail, pulling socket 20 connected to drive shaft DS is connected with connecting end 16 connected with the end of actuating rod 3 protruding forward from driver 2, and then assembly is finished by combining supporting member 12 such that actuating rod 3 protruding forward from driver 2 passes through the center of supporting member 12.

Pulling socket 20 may be connected with connecting end 16 after being fastened to threaded shaft B of drive shaft DS, after the jig assembly is moved to where drive shaft DS fits into axle hub AH, because connecting end 16 is separately formed by pulling socket 20.

On the other hand, depending on various configurations of the direct shaft-pulling member that is connected to the front of driver 2, a simple locking mechanism may be used without connecting end 16 and pulling socket 20, that is, as shown in FIG. 3, by locking driving connection step 300 directly formed on actuating rod 113 of driver 2 to driven connection step 400 of pulling member 120 threaded-fastened to drive shaft DS.

Accordingly, as pulling member 120 is axially pulled through driving connection step 300 and driven connection step 400 by the axial pulling force of driver 2, drive shaft DS threaded-fastened to threaded shaft 123 of pulling member 120 is correspondingly axially pulled and forcibly fitted into axle hub AH.

An indirect shaft-pulling member, another modification for the above shaft-pulling member, can be applied, that is, as shown in FIG. 4, by connecting driving connection end 101 formed at the end of actuating rod 113 of driver 2 and driven connection end 102 of pulling member 120 with threaded shaft 123 threaded-fastened to drive shaft DS using indirect connecting members 103 and then fixing indirect connecting members 103 with nuts.

According to this configuration, the axial pulling force applied to driving connection end 101 from driver 2 is transmitted through indirect connecting members 103 to driven connection end 102, which correspondingly pulls drive shaft DS threaded-fastened with pulling member 120 in the same axial direction.

Indirect connecting member 103 transmitting the axial pulling force from driver 2 is changeable in length according to the distance between driver 2 and drive shaft DS; therefore, even though the distance between driver 2 and drive shaft DS is increased, it is still possible to fit drive shaft DS in axle hub AH.

The complete jig assembly is moved to where drive shaft DS fits into axle hub AH and connected with the power source and controller, in which driver 2 is connected with the power source through a pipe and an electrical circuit is built to the controller.

Further, an electrical circuit is built to the controller for operation switch 19 provided at left/right bars 10, 11 to operate driver 2.

In fitting drive shaft DS into axle hub AH using the jig assembly having the above configuration, since drive shaft DS is axially pulled, drive shaft DS is fitted in axle hub AH after being assembled in advance with the differential of the axle that is assembled in the assembly line.

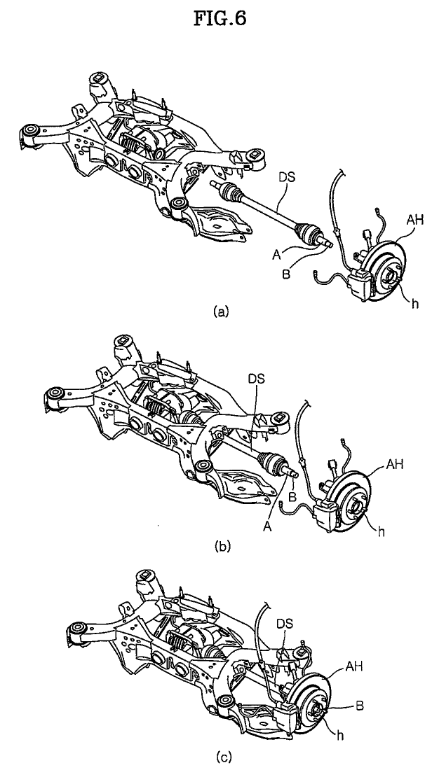

In detail, after drive shaft DS is moved to the axle in the assembly line, as shown in FIGS. 6A to 6C, an end of drive shaft DS is assembled in advance with the differential of the axle, a fitted-shaft A formed at the other end of drive shaft DS is fitted in hub h of axle hub AH, and threaded shaft B formed on fitted-shaft A of drive shaft DS protrudes a predetermined length from hub h of axle hub AH.

As described above, since drive shaft DS to fit in axle hub AH is assembled with the differential of the axle and then fitted in axle hub AH, it is possible to prevent damage to the differential and trailing arm.

Therefore, when drive shaft DS is fitted in axle hub AH in advance and then assembled with differential of the axle, the oil seal provided to the differential is frequently damaged by drive shaft DS inserted, due to inattention in assembling drive shaft DS with the differential; however, according to the jig assembly of the invention, since drive shaft DS is assembled with the differential and then fitted into axle hub AH, so that the above damage can be prevented.

Further, when drive shaft DS is fitted in axle hub AH in advance and then assembled with the differential of the axle, interference is caused between the trailing arm assembled with the axle and axle hub AH depending on the structure, drive shaft DS fitted in axle hub is difficult to assemble with the differential of the axle without changing the mounting position of the knuckle; however, according to the jig assembly of the invention, since drive shaft DS is assembled with the differential of the axle and then fitted into axle hub AH, so that the above problem can also be prevented.

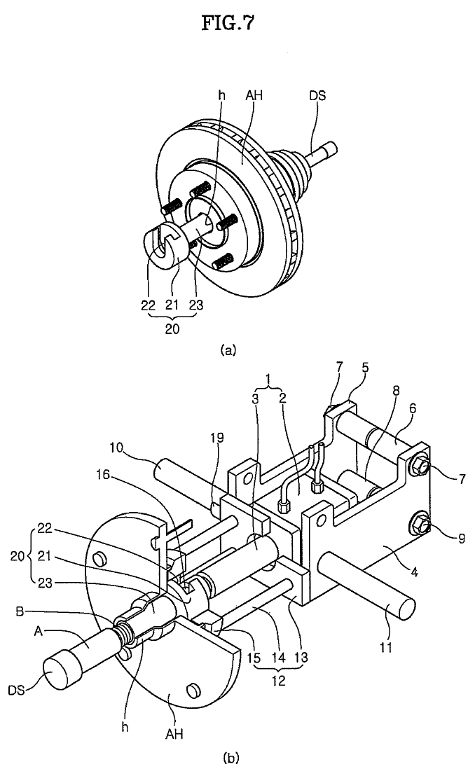

When threaded shaft B of fitted-shaft A of drive shaft DS protrudes to hub h of axle hub AH after drive shaft DS is assembled with the differential of the axle, as shown in FIG. 7A, pulling socket 20 is threaded-fastened to threaded shaft B of drive shaft DS.

Specifically, when pulling socket 20 is connected with drive shaft DS by threaded-fastening extended threaded shaft 23 to threaded shaft B of drive shaft DS protruding to hub h of axle hub AH through inside-threaded end 23a, the fitting preparation step is completed in which drive shaft DS and pulling socket 20 are positioned on the axis of hub h of axle hub AH.

Since diameter d of extended threaded shaft 23 of pulling socket 20 is the same as or a little less than diameter c of hub h of axle hub AH, extended threaded shaft 23 can be easily inserted into hub h of axle hub AH with small force.

As shown in FIG. 7B, connecting end 16 connected to driver 2 is fitted into pulling socket 20 threaded-fastened to drive shaft DS by fitting insert end 18 of connecting end 16 into connection groove 22 of socket end 21 of pulling socket 20.

In detail, as insert end 18 of connecting end 16 is fitted into open slot 22b of connection groove 22, it is locked to the inside of insertion 22a that forms the inner space communicated with open slot 22b. Accordingly, insert end 18 is in contact with the inside of socket end 21 having the insertion 22a and the load from driver 2 that axially pulls connecting end 16 is exerted in the entire pulling socket 20.

As described above, when driver 2 is operated with the jig assembly connected with drive shaft DS, drive shaft DS is fitted into hub h of axle hub AH by the axial pulling force from driver 2.

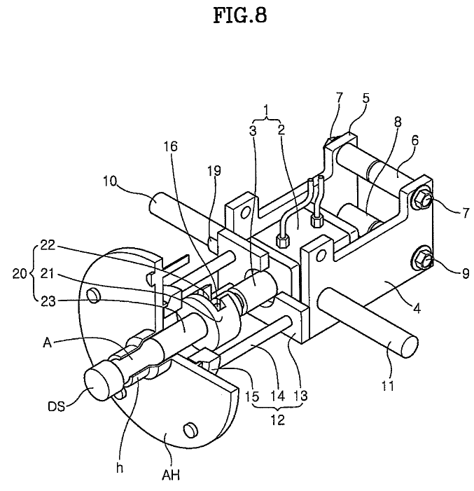

As shown in FIG. 8, when an operator operates operation switch 19 and driver 2 is in operation, the axial pulling force from driver 2 pulls connecting end 16 through actuating rod 3 and correspondingly pulls pulling socket 20 connected with connecting end 16.

When the indirect shaft-pulling member of connecting end 16 and pulling socket 20 is strongly pulled by driver 2, fitted-shaft A of drive shaft DS threaded-fastened with pulling socket 20 is forcibly fitted through hub h of axle hub AH by the axial pulling force.

The axial load from driver 2 ranges from about 700 kgf to 1600 kgf, depending on the specification of drive shaft DS to fit into axle hub AH.

Movement of axle hub AH with respect to drive shaft DS that is in axial motion is restricted while drive shaft DS is fitted into axle hub AH, because axle hub AH is restricted by supporting member 12.

Specifically, as the indirect shaft-pulling member of connecting end 16 and pulling socket 20 is connected with drive shaft DS, positioner 15 of supporting member 12 closely contact with the surface of axle hub AH, positioner 15 is restricted by supporting case 13 fixed to driver 2 through supporting bars 14. As a result, drive shaft DS restricts the movement force applied to axle hub AH while being axially pulled, so that the movement of axle hub AH is restricted.

As described above, when drive shaft DS is axially pulled by driver 2, connecting end 16, and pulling socket 20 and threaded shaft B of drive shaft DS completely protrude through hub h of axle hub AH, an operator stops driver 2 and separates pulling socket 20 from threaded shaft B of drive shaft DS, and moves the jig assembly.

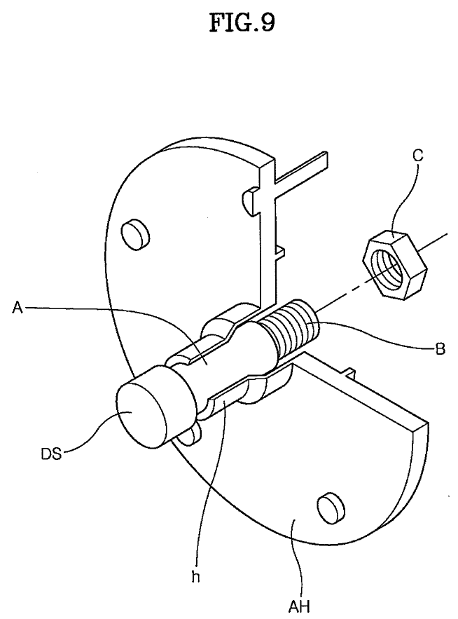

FIG. 9 shows drive shaft DS fitted in axle hub AH with the jig assembly separated. When threaded shaft B of drive shaft DS is drawn out of hub h of axle hub AH, an operator finishes the fitting by screwing nuts, finishing members C, to threaded shaft B of drive shaft DS to fix drive shaft DS.

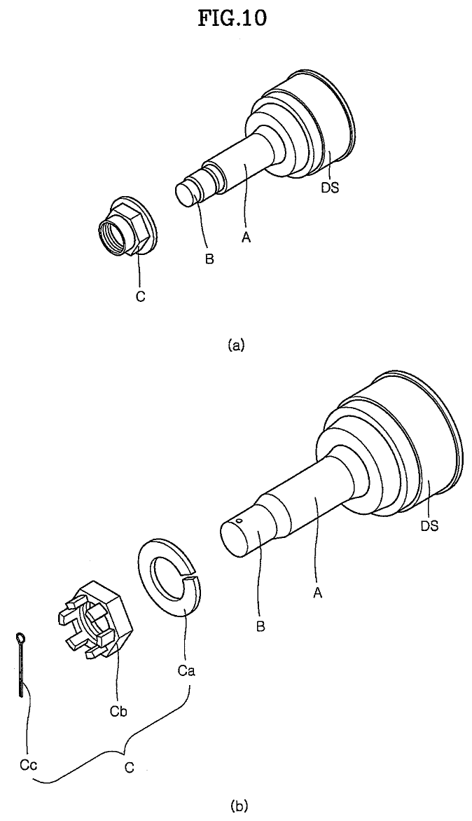

Finishing members C that is fastened to drive shaft DS forcibly fitted in axle hub AH may be fastened in a variety of ways to remove insecurity when only nuts are used. For example, as shown in FIG. 10A, when a caulking nut is used as finishing member C to fasten to threaded shaft B of drive shaft DS, it is possible to achieve simple configuration and secure fastening that are the advantages of the caulking nut, and waterproof and stable torque as well.

Further, though it is not preferred as compared with a caulking nut as finishing member C to fasten to threaded shaft B of drive shaft DS, separate pins may be applied. As shown in FIG. 10B, finishing member C is composed of a washer Ca, a nut Cb, and a separated pin Cc, which are sequentially fastened to threaded shaft B of drive shaft Ds.

As described above, since the axial load applied to drive shaft by the pulling type drive shaft-fitting jig assembly ranges from about 700 kgf to 1600 kgf, the jig assembly of the invention has the advantage of setting in advance the axial load from driver 2 corresponding to the specification of drive shaft DS or conveniently using by controlling the axial load from driver 2.

According to the pulling type drive shaft-fitting jig assembly shown in FIG. 11, load setter 30 is disposed between connecting end 16 and pulling socket 20, the shaft-pulling member. When a load cell is used for load setter 30, fitting of drive shaft DS requiring axial load between about 700 kgf and 1600 kgf becomes more convenient because the axial load from driver 2 axially pulling drive shaft DS can be directly recognized by an operator or the controller.

Further, according to the pulling type drive shaft-fitting jig assembly of the invention, it is possible to set the axial load between about 700 kgf and 1600 kgf that is differently applied, depending on the specifications of drive shaft DS while remotely controlling driver 2 and it is correspondingly possible to rapidly cope with differences in fitting force of drive shaft DS with the pulling type drive shaft-fitting jig assembly directly installed in the vehicle assembly line.

According to the pulling type drive shaft-fitting jig assembly, as shown in FIG. 12, the shaft-pulling member composed of connecting end 16 and pulling socket 20 is connected to the shaft of driver 2 together with supporting member 12 restricting axle hub AH, the distance between driver 2 and the shaft-pulling member is maintained by connecting rods 42 of intermediate connecting member 40, and load setter 30 that detects axial load is installed on the axis of the reciprocating shaft of driver 2.

A jig assembly having the above configuration is directly installed in vehicle assembly lines and remotely controlled. As show in FIG. 13, when the jig assembly is move in an assembly line where the axle, drive shaft DS, and axle hub AH are assembled and moved, they are connected with a power source etc., and a power and signal input/output circuits are built for remote control through controller 60.

When the jig assembly is directly installed in a vehicle assembly line as described above, an operator can directly recognize the operational conditions of the jig assembly through controller 60 and set various control values.

Further, a jig assembly equipped with a load cell that is installed in vehicle assembly lines is the same in operation as the jig assembly of the invention, but the operation of load setter 30 and intermediate connecting member 40 is further provided, so it is mainly described herein.

According to the jig assembly shown in FIG. 13, it is possible to set axial load from driver 2 using controller 60 before the operation and control the axial load by the operation of driver 2. When an operator sets control values for the axial load (about 700 kgf to 1600 kgf) with an input/output device, load setter 30 is set to the control values by junction box 50 connected to controller 60.

When driver 2 is in operation, measured values form load sensor 32 that measures axial load information for pulling drive shaft DS are continuously inputted to connection end 31 set in the control values of controller 60, the axial load information is fed back to controller 60 through signal connection end 31, which allows an operator to take any necessary action immediately while continuously monitoring the operation of the jig assembly.

Further, connected to driver 2 through supporting bracket 41 and to supporting member 12 through connecting rods 42 integrally formed with supporting bars 14 at the opposite side, intermediate member 40 supports the movement of load setter 30 installed on the axis of driver 2, while supporting member 12 that is in close contact to the surface of axle hub AH.

As described above, according to the invention, since a jig assembly that forcibly fits the drive shaft into the axle hub operates such that the drive shaft is horizontally positioned with respect to the axial direction of the axle hub and pulled, it is not needed to provide separate supporting units or pressing means for the drive shaft to fit. Therefore, it is possible to independently manufacture the jig assembly from the drive shaft as compared with when the drive shaft vertically standing is pressed, and reduce the entire size of the jig assembly to independently manufacture, and correspondingly minimize the work space occupied by the jig assembly.

Further, according to the invention, when the drive shaft is pulled to forcibly fit into the axle hub, the drive shaft is guided by the pulling socket that is fitted in advance into the hub, the connection hole, of the axle hub. Therefore, it is possible to prevent damage to peripheral parts, such as the constant velocity joint, due to the drive shaft forcibly fitted and deterioration in quality.

Further, according to the invention, since the drive shaft, axle hub, and jig assembly are arranged in the same horizontal direction, it is not needed to provide equipment for supporting and pressing the drive shaft and it is possible to reduce the size of the entire equipment within the movable range and save manufacturing and managing costs.

Further, since the drive shaft is strongly pulled by the jig assemble opposite to the axle hub using hydraulic or pneumatic pressure, with the axle hub, drive shaft, and jig horizontally arranged on the same axis, the operation for supporting and fixing the axle hub and drive shaft is not substantially required, so that one operator can sufficiently work needed.

Further, according to the invention, since the jig assembly that axially pulls the drive shaft is provided with a load sensor that sets and measures the axial load and installed in a vehicle assembly line where parts of various specifications are assembled together, it is possible to set the axial load between about 700 kgf and 1600 kgf according to the specifications of the drive shaft and an operator can directly check changes in the axial load, which allows accurate and convenient work.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A pulling type drive shaft-fitting jig assembly comprising:
a driving means generating power; and
a shaft pulling maintainer disposed between a reciprocating shaft of the driving means and a drive shaft forcibly fitted into an axle hub such that the axis of the driving means is arranged in the axis direction of the drive shaft in order to pull the drive shaft using axial load from the driving means,
wherein the jig assembly is controlled by the driving means and a controller of a control circuit.

2. The jig assembly as defined in claim 1, wherein the driving means generates axial pulling force using hydraulic pressure supplied from a power source through a pipe connecting the power source and driving means and has an operation switch transmitting operational signals to the controller for generating axial pulling force and
the shaft pulling maintainer has a supporting member that supports the sides of the axle hub to restrict axial movement of the axle hub, when the drive shaft is axially pulled, and a shaft-pulling member that axially pulls the drive shaft using the axial pulling force transmitted from the driving means is disposed at the inside from the supporting member.

3. The jig assembly as defined in claim 2, wherein the driving means includes a driver equipped with an actuating rod that reciprocates when the driving means generates axial load, both sides of the driver is covered by housing cases and upper/lower guide bars are fixed to the housing cases by fastening bolts that are threaded-fastened.

4. The jig assembly as defined in claim 2, wherein the supporting member includes long shaft-shaped bars to maintain a predetermined interval between the axle hub and the driver of the driving means, and
one end of the supporting bar is connected to a supporting case with a through hole in front of the driver in order not to interrupt movement of the shaft of the driver and the other end is connected with a positioner that is in close contact with the surface of the axle hub and restricts the axle hub when the drive shaft is axially moved.

5. The jig assembly as defined in claim 2, wherein the shaft-pulling member includes:
a connecting end that is connected to the shaft of the driver and transmits the axial pulling force; and
a pulling socket that is connected to the end of the driving shaft to forcibly fit the drive shaft into the hub of the axle hub and to connecting end on the same axis as the connecting end.

6. The jig assembly as defined in claim 5, wherein the shaft-pulling member operates in a direct type such that the connecting end is connected with the pulling socket without a gap and axial load is directly transmitted to the pulling socket through the connecting end, and the direct shaft-puling member has an insert end that is formed at the opposite side to a connection shaft that is connected to the actuating rod of the driver, with a step between the insert end and the connection shaft, and the pulling socket has a connection groove to fit the insert end, opposite to a hollow extending connection shaft connected to the drive shaft.

7. The jig assembly as defined in claim 6, wherein the connection groove of the pulling socket has an open slot that is open to a side to easily fit the insert end of the connecting end and an insertion that is in close contact with the sides to axially restrict the fitted insert end.

8. The jig assembly as defined in claim 6, wherein the extending connection shaft of the pulling socket has an inside-threaded end for threaded-fastening with a threaded shaft at the end of the drive shaft, and the threaded-fastened portion is made of a material that has undergone heat treatment or has sufficient rigidity against the axial load when the drive shaft is pulled.

9. The jig assembly as defined in claim 2, wherein the shaft-pulling member operates in a direct shaft-pulling type using a pulling member in which a drive connection step is directly formed on an actuating rod of the driver and a driven connection step that is locked with the driving connection step is formed on a driven body opposite to a hollow threaded shaft that is threaded-fastened with the end of the drive shaft.

10. The jig assembly as defined in claim 2, wherein the shaft-pulling member is an indirect shaft-pulling member with a long distance between the driver and the drive shaft.
wherein the indirect shaft-pulling member includes: a driving connection end formed in a larger diameter than the actuating rod of the driver at the end of the actuating rod; a driven connection end formed in a larger diameter than the pulling member with a driven body at the opposite side to the hollow threaded shaft; and indirect connecting members that connects the driving connection end and the driven connection end through holes formed in the driving connection end and the driven connection end to transmit axial pulling force exerted in the driving connection end.

10. The jig assembly as defined in claim 10, wherein the indirect connecting members are long shaft-shaped bars with threads on both ends, inserted into the holes of the driving connection end and the driven connection end, and then fixed by screwing nuts, fixing members, onto both ends.

12. The jig assembly as defined in claim 10, wherein the indirect connecting member is a steel wire.

13. The jig assembly as defined in claim 1, wherein a finishing member that is fastened to the drive shaft forcibly fitted in the axle hub by the operation of the driving means, shaft pulling maintainer, and controller is a caulking nut screwed onto the threaded shaft of the drive shaft protruding through the axle hub.

14. The jig assembly as defined in claim 13, wherein the finishing member is composed of a washer, a nut, and a separate pin.

15. The jig assembly as defined in claim 1, wherein a load setter is further provided to the shaft pulling maintainer to check the axial load exerted in the drive shaft pulled by the power from the driving means.

16. The jig assembly as defined in claim 15, wherein the load setter is disposed between the driving means and the shaft-pulling member having the pulling socket connected to the drive shaft and the connecting end connected to the driving means to axially pull the drive shaft.

17. The jig assembly as defined in claim 16, wherein the load setter is a load cell.

18. The jig assembly as defined in claim 1, wherein the shaft pulling maintainer has the load setter to check axial load exerted in the drive shaft pulled by the power from the driving means,
intermediate connecting members maintaining a predetermined interval of the front and rear of the load setter are provided on the axis of the driving means around the load setter, and
the controller that inputs/outputs control signals generates control signals to operate the driving means and is controlled with the load setter in feed-back type.

19. The jig assembly as defined in claim 18, wherein the load setter is disposed between the connecting end, which is disposed at the inside from the supporting member supporting the sides of the axle hub when the drive shaft is forcibly fitted, and fitted in the pulling socket threaded-fastened to axially pull the drive shaft, and the shaft of the driver connected to apply axial pulling force from the hydraulic driver of the driving means to the connecting end, such that the shaft of the driver passes through, and connected through the controller and a junction box.

20. The jig assembly as defined in claim 19, wherein the load setter includes:
a signal connection end connected to the controller to transmit axial load signals or input control signals; and
a load sensor with the signal connection end at one side that is disposed around the actuating rod of the driver such that the actuating rod passes through.

21. The jig assembly as defined in claim 20, wherein the load sensor is formed in a load cell type.

22. The jig assembly as defined in claim 20, wherein a hollow shaft connection end axially protruding is formed at a side of the load sensor around the protruding shaft of the driver.

23. The jig assembly as defined in claim 18, wherein the intermediate connecting member is connected to the driver through a supporting bracket, and
an interval from the load setter is defined by connecting rods of which one ends are connected to the supporting bracket and the other ends are connected to the supporting case that is in close contact with the load setter opposite to the supporting bracket.

24. The jig assembly as defined in claim 23, wherein the intermediate connecting member is disposed between the driver of the driving means and the supporting member having the positioner that is in close contact with the surface of the axle hub and the supporting bars that connect the positioner with the supporting case, and
the connecting rods of the intermediate connecting member are integrally formed with the supporting bars.
